(19) United States
(12) Patent Application Publication
(10) Pub. No.: US 2026/0337334 A1
(43) Pub. Date: Oct. 29, 2026

(54) MODIFIED POLYESTER COMPRISING IONIC COMONOMER

(71) Applicant: SHINKONG SYNTHETIC FIBERS CORPORATION, TAIPEI CITY (TW)

(72) Inventors: YEN-HAO TSENG, TAIPEI CITY (TW); PO-HAO HUANG, TAIPEI CITY (TW); HUI-MING SU, TAIPEI CITY (TW); CHIU-YEN CHEN, TAIPEI CITY (TW)

(21) Appl. No.: 19/188,949

(22) Filed: Apr. 24, 2025

(51) Int. Cl. C08G 63/688; C08G 63/85; C08J 5/18

(52) U.S. Cl. CPC C08G 63/6886; C08G 63/85; C08J 5/18; C08J 2367/02

(57) ABSTRACT

A recycled thermoplastic polyester elastomer (TPEE) is provided herein. The TPEE comprises a rigid segment and a flexible segment chemically bonded to each other, wherein the rigid segment comprises a polyester, a polyol, and an ionic comonomer, and the flexible segment comprises a polyether. The rigid segment constitutes approximately 15% to 75% by weight of the total TPEE weight, whereas the flexible segment constitutes approximately 20% to 80% by weight. Additionally, within the rigid segment, the ionic comonomer is present in a molar percentage (mol %) of 0.1 to 20 relatives to the total molar amounts of the polyester. Also provided herein are a waterproof breathable film comprising the disclosed TPEE and a method for producing the TPEE.

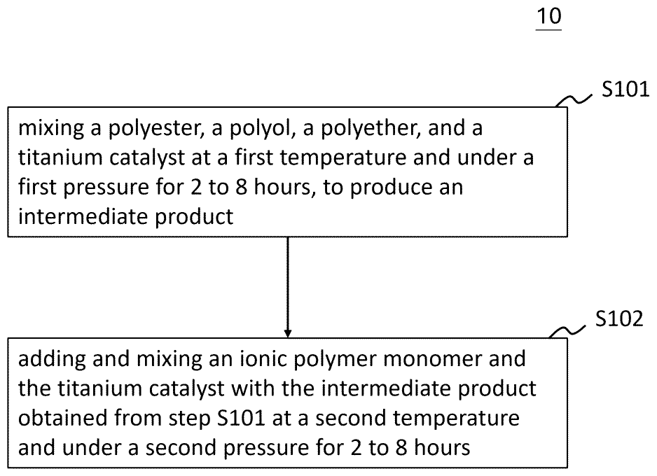

### BACKGROUND OF THE INVENTION

### 1. Field of the Invention

The present disclosure relates to the field of recycled thermoplastic polyester elastomer (TPEE) with improved moisture permeability and a method for producing said TPEE.

### 2. Description of Related Art

Recycled thermoplastic polyester elastomer (TPEE-R) is a class of environmentally friendly materials that combine the advantages of both thermoplastics and elastomers. These materials typically consist of a rigid (hard) segment and a flexible (soft) segment, allowing them to be processed and reshaped upon heating while still maintaining elasticity and flexibility. TPEE-R is derived from recycled sources, contributing to sustainability by reducing plastic waste. Due to its unique structure, it is widely used in applications requiring both mechanical durability and a soft-touch feel.

One of the key challenges in developing elastomeric materials is balancing their mechanical properties with the desired moisture permeability. For instance, polyethylene glycol (PEG), also known as poly(oxyethylene) (POE), is commonly used as a hydrophilic component to enhance moisture absorption and transport. However, excessive incorporation of PEG can significantly weaken the mechanical strength of the material, leading to reduced durability and performance. Achieving an optimal formulation requires careful selection of soft and rigid segments to ensure that both structural integrity and moisture permeability are maintained.

In view of the foregoing, there is a need in the related art for an improved TPEE-R that exhibits enhanced moisture permeability while maintaining excellent tensile properties.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

As embodied and broadly described herein, the purpose of the present disclosure is to provide an improved thermoplastic polyester elastomer (TPEE) that exhibits enhanced moisture permeability while maintaining excellent tensile properties. A waterproof breathable film comprising the present TPEE, and a method for producing the present TPEE are also provided herein.

In one aspect, the present disclosure is directed to a thermoplastic polyester elastomer (TPEE) comprising a rigid segment and a flexible segment connected with each other through chemical bonds, wherein the rigid segment comprises a polyester, a polyol, and an ionic comonomer, and the flexible segment comprises a polyether; the rigid segment is present in about 15% to 75% by weight percentage (wt %) of the total weight of the TPEE, and the flexible segment is present in about 20% to 80% by weight percentage (wt %) of the total weight of the TPEE; and in the rigid segment, the ionic comonomer is present in a molar percentage (mol %) of 0.1 to 20 relatives to the total molar amounts of the polyester.

According to some embodiments of the present disclosure, the polyester is a recycled polyester. Examples of polyesters suitable for use in the present TPEE include, but are not limited to, polyethylene terephthalate (PET), polybutylene terephthalate (PBT), polytrimethylene terephthalate (PTT), polylactic acid (PLA), polycyclohexylene dimethylene terephthalate (PCT), polyethylene naphthalate (PEN), liquid crystal polyester (LCP), and a combination thereof. Preferably, the polyester for use in the present TPEE is PET.

According to the present disclosure, examples of polyols suitable for use in the present TPEE include, but are not limited to, 1,4-butanediol (BDO), ethylene glycol (EG), 1,6-hexanediol (HDO), neopentyl glycol (NPG), and a combination thereof. Preferably, the polyol for use in the present TPEE is BDO.

According to the present disclosure, examples of ionic comonomers suitable for use in the present TPEE include, but are not limited to, sodium dimethyl 5-sulphonatoisophthalate (DMSIP), sodium 4-vinylbenzenesulfonate (SSS), sodium methacrylate (SMA), potassium 3-sulfopropyl methacrylate (SPMA), poly(sodium styrene sulfonate) (PSS), and a combination thereof. In one preferred example of the present disclosure, the ionic comonomer is DMSIP.

According to the present disclosure, examples of polyethers suitable for use in the present TPEE include, but are not limited to, polyethylene glycol (PEG), polypropylene glycol (PPG), polytetramethylene ether glycol (PTMEG), polytetrahydrofuran (PTHF), poly(ethylene-co-propylene) glycol (PEPG), polyoxetane (POX), and a combination thereof. In one preferred embodiment of the present disclosure, the polyether is PEG.

In one preferred working example, in the TPEE, the rigid segment is composed of a recycled polyethylene terephthalate (rPET), BDO, and DMSIP; and the flexible segment is composed of PEG. In one preferred working example, the rigid and flexible segments are connected with each other through ester bonds.

According to some embodiments of the present disclosure, the rigid segment is present in about 45% to 55% by weight (wt %) of the total weight of the TPEE, and the flexible segment is present in about 40% to 50% by weight of the total weight of TPEE.

According to some embodiments of the present disclosure, in the present TPEE, the ionic comonomer is present in a molar percentage (mol %) of 10 to 20 relatives to the total molar amounts of the polyester.

According to some embodiments of the present disclosure, the TPEE is characterized by having a moisture vapor transmission rate (MVTR) greater than 30,000 g/m²·24 h.

In another aspect, the present disclosure pertains to a waterproof breathable film comprising the thermoplastic polyester elastomer (TPEE) aforementioned. According to some embodiments of the present disclosure, the waterproof breathable film has a thickness of 10 to 450 μm.

Preferably, the waterproof breathable film is characterized by having a moisture vapor transmission rate (MVTR) greater than 30,000 g/m²·24 h.

In still another aspect, the present disclosure pertains to a method for producing a thermoplastic polyester elastomer (TPEE), particularly the TPEE aforementioned. The method comprises at least the following steps: (a) mixing a polyester, a polyol, a polyether, and a titanium catalyst at a first temperature ranging from 200 °C to 250 °C and a first pressure for 2 to 8 hours, to produce an intermediate product; and (b) adding and mixing an ionic comonomer and the titanium catalyst with the intermediate product obtained from step (a) at a second temperature ranging from 220 °C to 270 °C and a second pressure for 2 to 8 hours, thereby producing the present TPEE. According to some embodiments of the present disclosure, in the present method, the second temperature is greater than the first temperature. In addition, according to some embodiments of the present disclosure, the ionic comonomer is added in step (b) with a molar percentage (mol %) of 0.1 to 20 relative to the total molar amount of the polyester in step (a).

According to some embodiments of the present disclosure, examples of the titanium catalysts suitable for use in step (a) of the present method include, but are not limited to, titanium butoxide (Ti(OBu)₄), titanium tetrachloride (TiCl₄), titanium isopropoxide (Ti[OCH(CH₃)₂]₄), titanium (IV) acetylacetonate (Ti(acac)₄), titanium dioxide (TiO₂), and a combination thereof. In one preferred working example, the titanium catalyst is titanium butoxide.

According to some embodiments of the present disclosure, either in the step (a) or (b) of the method, the titanium catalyst is added at an amount of 0.01 to 1 mmol.

According to some embodiments of the present disclosure, in step (a) of the method, the polyol is added in an amount equal to or greater than the weight of the polyester.

According to some embodiments of the present disclosure, in step (a) of the method, the first pressure is about 1 atm to 2.5 atm; and in step (b) of the method, the second pressure is about less than 0.05 atm.

In some embodiments of the present disclosure, the polyester suitable for use in the present method is a recycled polyester. Examples of polyesters suitable for use in step (a) of the present method include, but are not limited to, polyethylene terephthalate (PET), polybutylene terephthalate (PBT), polytrimethylene terephthalate (PTT), polylactic acid (PLA), polycyclohexylene dimethylene terephthalate (PCT), polyethylene naphthalate (PEN), liquid crystal polyester (LCP), and a combination thereof.

According to some embodiments of the present disclosure, examples of polyols suitable for use in the present method include, but are not limited to, 1,4-butanediol (BDO), ethylene glycol (EG), 1,6-hexanediol (HDO), neopentyl glycol (NPG), and a combination thereof.

According to some embodiments of the present disclosure, examples of ionic comonomers suitable for use in the present method include, but are not limited to, sodium dimethyl 5-sulphonatoisophthalate (DMSIP), sodium 4-vinylbenzenesulfonate (SSS), sodium methacrylate (SMA), potassium 3-sulfopropyl methacrylate (SPMA), poly(sodium styrene sulfonate) (PSS), and a combination thereof.

According to some embodiments of the present disclosure, examples of polyethers suitable for use in the present method include, but are not limited to, polyethylene glycol (PEG), polypropylene glycol (PPG), polytetramethylene ether glycol (PTMEG), polytetrahydrofuran (PTHF), poly(ethylene-co-propylene) glycol (PEPG), polyoxetane (POX), and a combination thereof.

In one preferred embodiment of the present disclosure, the polyester is a recycled polyethylene terephthalate (rPET), the polyol is BDO, the polyether is PEG, and the ionic comonomer is DMSIP.

According to alternative or optional embodiments, in step (b) of the present method, an antioxidant may be further mixed with the ionic comonomer, the titanium catalyst, and the intermediate product.

By virtue of the above configuration, the present TPEE produced by the aforementioned method, and the waterproof breathable film comprising the TPEE, exhibits high moisture permeability while maintaining excellent tensile properties.

Many of the attendant features and advantages of the present disclosure will become better understood with reference to the following detailed description considered in connection with the accompanying drawings.

### BRIEF DESCRIPTION OF THE DRAWING

The present description will be better understood from the following detailed description read in light of the accompanying drawing, where:

The sole FIGURE is a flow chart of a method according to one embodiment of the present disclosure.

In accordance with common practice, the various described features/elements are not drawn to scale but instead are drawn to best illustrate specific features/elements relevant to the present invention. Also, like reference numerals and designations in the various drawings are used to indicate like elements/parts.

### DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

### 1. Definition

For convenience, certain terms employed in the specification, examples and appended claims are collected here. Unless defined otherwise, all technical and scientific terms used herein have the same meaning as commonly understood by one of the ordinary skill in the art to which this invention belongs.

The singular forms “a”, “and”, and “the” are used herein to include plural referents unless the context clearly dictates otherwise.

The recitation of ranges of values herein is merely intended as a shorthand method of individually referring to each separate value within the range. Unless otherwise indicated, each individual value is incorporated into the specification as if it were explicitly recited.

As used herein, the term “about” means within an acceptable error range for a particular value as determined by one of ordinary skill in the art, which will depend in part on how the value is measured or determined, i.e., the limitations of the measurement system. Unless explicitly stated otherwise within the Examples or elsewhere in the Specification in the context of a particular assay, result or embodiment, the term “about” means within one standard deviation per the practice in the art, or a range of up to 1%, 2%, 3%, 4%, 5%, 6%, 7%, 8%, 9%, 10%, 11%, 12%, 13%, 14%, 15%, 16%, 17%, 18%, 19% or 20%.

As used herein, the terms “comprises,” “comprising,” “includes,” “including,” “has,” “having,” “contains,” “containing,” or any variation thereof are intended to indicate a non-exclusive inclusion, subject to any limitations explicitly stated. For example, a composition, mixture, process, or method that comprises a list of elements is not necessarily limited to only those elements but may also include other elements not expressly listed or inherent to such a composition, mixture, process, or method.

The expressions “in one embodiment,” “in some embodiments,” and similar phrases as used herein generally indicate that the particular feature, structure, or characteristic described following the phrase may be included in at least one embodiment of the present disclosure and potentially in multiple embodiments (notably, such phrases do not necessarily refer to the same embodiment). The use of examples or exemplary language (e.g., ‘such as’) provided herein is intended solely to illustrate the present disclosure and does not limit its scope as otherwise claimed. No language in the specification should be construed as indicating that any non-claimed element is essential to the practice of the present disclosure.

All methods described herein may be performed in any suitable order unless explicitly stated otherwise or clearly contradicted by the context.

The term “ionic comonomer” as used herein refers to a monomer containing one or more ionic functional groups, such as sulfonate (—SO₃⁻), carboxylate (—COO⁻), phosphate (—PO₄³⁻), or ammonium (—NR₄⁺) groups, which can participate in polymerization to form ion-containing polymers (ionomers, polyelectrolytes, or ionic copolymers). These monomers introduce ionic interactions into the polymer structure, affecting properties such as hydrophilicity, conductivity, mechanical strength, and thermal stability.

The term “moisture vapor transmission rate” or “MVTR” used herein measures the amount of water vapor that passes through a material over a specific time period, often expressed in grams per square meter per day (g/m²/day) or grams per square meter per 24 hours (g/m²/24 h). It indicates the permeability of vapor barriers; a higher number signifies greater moisture permeability.

As used herein, the term “weight percentage” (wt %) refers to the percentage by weight of a given component relative to the total weight of the thermoplastic polyester elastomer (TPEE). Unless otherwise specified, all percentages herein are expressed as weight percentages based on the total weight of the TPEE. According to certain embodiments, the rigid segment may account for 15% to 75% by weight of the TPEE (e.g., 15, 20, 25, 30, 35, 40, 45, 50, 55, 60, 65, 70, or 75 wt %), while the flexible segment may account for 20% to 80% by weight of the TPEE (e.g., 20, 25, 30, 35, 40, 45, 50, 55, 60, 65, 70, 75, or 80 wt %).

As used herein, the term “molar percentage” (mol %) refers to the ratio, expressed as a percentage, of the number of moles of a given component (e.g., component A) to the number of moles of another specified component (e.g., component B), with component B serving as the reference. In some embodiments of the present disclosure, during the preparation of the thermoplastic polyester elastomer (TPEE), the amount of the ionic comonomer is expressed as a molar percentage relative to the total number of moles of polyester used in the formulation. That is, the mol % value reflects the proportion of the ionic comonomer based on the total molar amount of polyester. Specifically, the molar percentage of the ionic comonomer may range from 0.1% to 20%, such as 0.1, 0.2, 0.3, 0.4, 0.5, 0.6, 0.7, 0.8, 0.9, 1.0, 2.0, 3.0, 4.0, 5.0, 6.0, 7.0, 8.0, 9.0, 10.0, 10.5, 11.0, 11.5, 12.0, 12.5, 13.0, 13.5, 14.0, 14.5, 15.0, 15.5, 16.0, 16.5, 17.0, 17.5, 18.0, 18.5, 19.0, 19.5, and 20.0 mol %.

### 2. Exemplary Embodiments

The present disclosure is based, at least in part, on the discovery that adding ionic comonomers in a controlled ratio with polyol during TPEE preparation enhances moisture permeability while maintaining physical properties of the produced TPEE. Accordingly, the present disclosure provides a novel TPEE with improved properties and high moisture permeability, along with a waterproof breathable film comprising the TPEE, and its production methods.

### 2.1 Thermoplastic Polyester Elastomer (TPEE) and Methods for Producing the Same

The first aspect of the present disclosure is directed to a thermoplastic polyester elastomer (TPEE) and a method for producing the same. Reference is made to the sole FIGURE.

The sole FIGURE is a flow chart of a method 10 for producing TPEEs according to one embodiment of the present disclosure. The method 10 comprises at least the following steps, which are respectively indicated by reference numbers S101 to S102 in the sole FIGURE:
S101: mixing a polyester, a polyol, a polyether, and a titanium catalyst at a first temperature ranging from 200 °C to 250 °C and under a first pressure for 2 to 8 hours, to produce an intermediate product; and
S102: adding and mixing an ionic comonomer and the titanium catalyst with the intermediate product obtained from step S101 at a second temperature ranging from 220 °C to 270 °C and under a second pressure for 2 to 8 hours, thereby producing the present TPEE.

The process begins with catalyzing the alcoholysis reaction using a titanium catalyst at a specific temperature by mixing a polyester, a polyol, a polyether, and a titanium catalyst in a first reactor at a first temperature and under a first pressure for 2 to 8 hours (S101).

According to some embodiments of the present disclosure, the titanium catalyst can be an alkoxide-based, halide-based, acetylacetonate, or heterogeneous titanium catalysts. Non-limiting examples of titanium catalysts suitable for use in the present method include titanium butoxide (Ti(OBu)₄), titanium tetrachloride (TiCl₄), titanium isopropoxide (Ti[OCH(CH₃)₂]₄), titanium acetylacetonate (Ti(acac)₄), titanium dioxide (TiO₂), and a combination thereof. In one preferred working example, the titanium catalyst is titanium butoxide. The amount of titanium catalyst can be added according to practical needs. According to some embodiments of the present disclosure, the titanium catalyst is added in an amount ranging from 0.01 to 1 mmol, preferably about 0.1 to 0.3 mmol.

Alternatively or optionally, the titanium catalyst can be prepared by coordinating polyols with titanium atoms to form a polyol-coordinated titanium catalyst (coordination-modified titanium catalyst) for performing the alcoholysis of polyesters and reacting with polyols to produce a TPEE. The polyols used for coordinating titanium are different from those used in step S101. Typically, the titanium catalyst for use in the present method may be prepared by reacting titanium compounds with polyols at a molar ratio of about 1:1 to 1:3, such as 1:1, 1:2, or 1:3. Non-limiting examples of the titanium compounds include tetramethoxy titanium (TMT), tetraethoxy titanium (TET), tetraisopropoxy titanium (TPT), or tetrabutoxy titanium (TBT). Non-limiting examples of polyols suitable for use in coordination include xylitol, sorbitol, maltitol, erythritol, or mannitol. Optionally, the catalyst can be further reacted with titanium atoms and alkali at a molar ratio of approximately 1:1 to 100:1 to enhance its stability in water. Non-limiting examples of alkali compounds include amine compounds or alkali metal compounds, such as lithium hydroxide, sodium hydroxide, ammonium hydroxide, tetrabutylammonium hydroxide, lithium carbonate, sodium carbonate, potassium carbonate, lithium acetate, sodium acetate, potassium acetate, or triethylamine.

In step S101, the amounts of polyester, polyol, and polyether can be adjusted according to practical needs, such as the weight ratio of the rigid segment to the flexible segment. According to embodiments of the present disclosure, the weight ratio of polyester to polyether can be about 1:5, 1:4, 1:3, 1:2, 1:1, 2:1, 3:1, 4:1, or 5:1. As for the polyol, it is added in an amount equal to or greater than the weight of the polyester. According to some embodiments of the present disclosure, the polyol is added in an amount greater than the weight of the polyester.

According to some embodiments of the present disclosure, the polyester is a recycled polyester. Specific examples of polyester suitable for production of the present TPEE include, but are not limited to, polyethylene terephthalate (PET), polybutylene terephthalate (PBT), polytrimethylene terephthalate (PTT), polylactic acid (PLA), polycyclohexylene dimethylene terephthalate (PCT), polyethylene naphthalate (PEN), and liquid crystal polyester (LCP).

Examples of polyether suitable for production of the present TPEE include, but are not limited to, polyethylene glycol (PEG), polypropylene glycol (PPG), polytetramethylene ether glycol (PTMEG), polytetrahydrofuran (PTHF), poly(ethylene-co-propylene) glycol (PEPG), and polyoxetane (POX).

Examples of polyol suitable for production of the present TPEE include, but are not limited to, 1,4-butanediol (BDO), ethylene glycol (EG), 1,6-hexanediol (HDO), and neopentyl glycol (NPG).

According to some embodiments of the present disclosure, in the first reactor, the reaction in step S101 is conducted at a first temperature ranging from 200 °C to 250 °C, preferably at 220 °C. Additionally, the first pressure in the first reactor is about 1 atm to 2.5 atm, such as 1, 1.5, 2, and 2.5 atm. According to some working examples, the reaction in step S101 is carried out at 1 atm for 6 hours, resulting in the formation of an intermediate product.

The intermediate product is transferred to the second reactor for the polymerization reaction (step S102). In this process, an ionic comonomer and the titanium catalyst are added to the second reactor to react with the intermediate product. The reaction is carried out at a second temperature ranging from 220 °C to 270 °C under a second pressure of less than 0.05 atm for 2 to 8 hours, preferably for 3 to 4 hours. The second temperature can be adjusted according to practical needs but must be higher than the first temperature. According to a specific embodiment, the second temperature is 245 °C, and the second pressure is reduced to below 1 torr (0.0013 atm).

According to some embodiments of the present disclosure, in step S102 of the present method, the ionic comonomer is added with a molar percentage (mol %) relative to the total molar amount of the polyester. Specifically, the molar percentage of the ionic comonomer ranges from 0.1 mol % to 20 mol %, such as, 0.1, 0.2, 0.3, 0.4, 0.5, 0.6, 0.7, 0.8, 0.9, 1.0, 1.0, 2.0, 3.0, 4.0, 5.0, 6.0, 7.0, 8.0, 9.0, 10.0, 11.0, 12.0, 13.0, 14.0, 15.0, 16.0, 17.0, 18.0, 19.0, or 20.0 mol %. In preferred embodiments of the present disclosure, the molar percentage of the ionic comonomer ranges from 10 mol % to 20 mol %. Examples of ionic comonomers suitable for use in the production of the present TPEE include sodium dimethyl 5-sulphonatoisophthalate (DMSIP), sodium 4-vinylbenzenesulfonate (SSS), sodium methacrylate (SMA), potassium 3-sulfopropyl methacrylate (SPMA), poly(sodium styrene sulfonate) (PSS), and a combination thereof, but are not limited thereto.

According to some embodiments of the present disclosure, in step S102, the titanium catalyst is added again in an amount ranging from 0.01 to 1 mmol, preferably about 0.1 to 0.3 mmol.

Additionally or optionally, an antioxidant can be added to the second reactor to mix with the ionic comonomer, the titanium catalyst, and the intermediate product. A suitable antioxidant can be selected according to the knowledge of those skilled in the art. In one working example, the antioxidant is a butylated hydroxytoluene derivative.

According to some embodiments of the present disclosure, the polyester in step S101 is a recycled polyethylene terephthalate (rPET), the polyol in step S101 is 1,4-butanediol (BDO), the polyether in step S101 is polyethylene glycol (PEG), and the ionic comonomer in step S102 is sodium dimethyl 5-sulphonatoisophthalate (DMSIP). After performing steps S101 and S102 under aforementioned conditions, a thermoplastic polyester elastomer (TPEE) comprising a rigid segment and a flexible segment is produced.

Next, the TPEE prepared according to the aforementioned method is further described. According to some embodiments of the present disclosure, the rigid segment and the flexible segment are connected with each other through chemical bonds. In certain embodiments of the present disclosure, the rigid segment of the thus-produced TPEE is composed of the polyester, the polyol, and the ionic comonomer (specifically, rPET, BDO, and DMSIP, respectively), while the flexible segment is composed of the polyether (specifically, PEG). Therefore, in this specific embodiment, the rigid segment and the flexible segment are bonded to each other via ester bonds.

The weight ratio (or weight percentage) of the rigid and flexible segments in the thus-produced TPEE depends on the amounts of starting materials used during preparation. According to some embodiments of the present disclosure, the rigid segment is present in about 15% to 75% by weight (wt %) of the total weight of the TPEE, such as 15, 20, 25, 30, 35, 40, 45, 50, 55, 60, 65, 70, and 75%. The flexible segment is present in about 20% to 80% by weight (wt %) of the total weight of the TPEE, such as 20, 25, 30, 35, 40, 45, 50, 55, 60, 65, 70, 75, and 80%. In some preferred embodiments, the rigid segment is present in about 45% to 55% by weight (wt %), such as 45, 46, 47, 48, 49, 50, 51, 52, 53, 54, and 55% of the total weight of the TPEE, while the flexible segment is present in about 40% to 50% (e.g., 40, 41, 42, 43, 44, 45, 46, 47, 48, 49, and 50%) by weight (wt %) of the total weight of the TPEE.

Similarly, the proportion of the ionic comonomer in the final TPEE product also depends on the amounts of starting materials used during preparation. According to some embodiments of the present disclosure, the ionic comonomer is present in a molar percentage (mol %) of 0.1% to 20% relative to the total molar amount of the polyester (e.g., rPET, in the present disclosure). For example, the molar percentage of the ionic comonomer (e.g., DMSIP) may be 0.1, 0.2, 0.3, 0.4, 0.5, 0.6, 0.7, 0.8, 0.9, 1.0, 2.0, 3.0, 4.0, 5.0, 6.0, 7.0, 8.0, 9.0, 10.0, 10.5, 11.0, 11.5, 12.0, 12.5, 13.0, 13.5, 14.0, 14.5, 15.0, 15.5, 16.0, 16.5, 17.0, 17.5, 18.0, 18.5, 19.0, 19.5, and 20.0%. In preferred working examples, the ionic comonomer is present in a molar percentage (mol %) of 10 to 20 relatives to the total molar amount of the polyester.

According to some embodiments of the present disclosure, after qualitative characterization, the TPEE of the present disclosure is characterized by having a tensile strength of 100 to 500 kgf/cm², a rubber hardness of 20 to 60 D, and a melting point of 150 to 210 °C.

By virtue of the configuration set forth above, the method of the present disclosure (including steps S101-S102), through the addition of a specific amount of ionic comonomer and a defined ratio of the ionic comonomer to polyester, results in the present TPEE exhibiting the desired physical properties.

### 2.2 Waterproof Breathable Films Comprising the TPEE

The present disclosure also aims to provide a waterproof breathable film comprising the TPEE according to some embodiments of the present disclosure. The waterproof breathable films are found to exhibit better moisture permeability when compared to the conventional films.

Specifically, the waterproof breathable film can be made directly from TPEE or from a combination of TPEE and other polymers. The TPEE material can be prepared into a non-porous waterproof breathable film using techniques and methods known to those skilled in the art. For example, the waterproof breathable film can be produced from TPEE through coextrusion, solvent casting, thermal lamination, and/or melt-blown extrusion processes, depending on practical needs. In some embodiments of the present disclosure, the waterproof breathable film is produced by using a T-die machine through a coextrusion procedure.

The thickness of the waterproof breathable film can be adjusted according to practical needs. For example, the thickness of the waterproof breathable film in the present disclosure can be adjusted to range from 10 to 450 μm by modifying the equipment (e.g., T-die machine). Preferably, the thickness of the waterproof breathable film is about 20 μm.

According to some embodiments of the present disclosure, the waterproof breathable film made of the TPEE as disclosed herein are characterized by excellent moisture permeability. According to specific embodiments of the present disclosure, standard testing using a fabric moisture permeability tester yields a moisture vapor transmission rate (MVTR) greater than 30,000 g/m²·24 h. Preferably, the MVTR of the waterproof breathable film ranges from about 50,000 to about 100,000 g/m²·24 h.

By virtue of the configuration set forth above, the waterproof breathable film comprising the present TPEE exhibiting an excellent moisture permeability.

### EXAMPLES

### Materials and Methods

### List of Chemicals

The chemicals and initial materials used in the present examples are listed in Table 1 below.

TABLE 1
List of Chemicals

Recycled Polyethylene terephthalate (rPET)
CAS No.: 25038-59-9
Repeat unit molecular weight: 192 g/mol
Benzene-1,4-dicarboxylic acid (Terephthalic acid)
CAS No.: 100-21-0
Molecular weight: 166 g/mol
1,4-Butanediol
CAS No.: 110-63-4
Molecular weight: 90 g/mol
Poly(oxyethylene) (Polyethylene glycol, PEG)
CAS No.: 25322-68-3
Molecular weight: 2000 g/mol
Sodium 5-sulfonate dimethyl isophthalate (sodium dimethyl 5-
sulphonatoisophthalate, DMSIP)
CAS No.: 3965-55-7
Molecular weight: 296 g/mol
Titanium Butoxide
CAS No.: 5593-70-4
Molecular weight: 340 g/mol
Sodium Acetate
CAS No.: 127-09-3
Molecular weight: 82 g/mol
Antioxidant
Commercial antioxidant Irganox ® 1010

### General Procedure for Thermoplastic Polyester Elastomer Preparation

Recycled PET (r-PET), 1,4-butanediol, polyethylene glycol (PEG, molecular weight 2000 g/mol), and titanium butoxide were added to the transesterification/ester exchange reaction vessel. The reaction was carried out at 220 °C for 6 hours under atmospheric pressure.

After completion of the ester exchange, the product was transferred to the polymerization reaction vessel. Ionic comonomer (e.g., DMSIP), sodium acetate, antioxidant (e.g., Irganox® 1010), and titanium butoxide were added. The temperature was raised to 245 °C while reducing the pressure to below 1 torr, and the reaction was maintained for 3 to 4 hours.

Upon reaching the specified mechanical torque value, the polymerization reaction vessel was depressurized to atmospheric pressure. The ester strands were then cooled in a water bath and subsequently cut into pellets using a pelletizer, completing the production of the recycled thermoplastic polyester elastomer resin (i.e., the TPEE of the present disclosure).

### Testing and Characterization of Physical Properties

### Tensile Strength (ASTM D638)

Tensile strength was measured using a universal testing machine. The material was molded into a dumbbell-shaped specimen and equipped with a two-point extensometer to accurately capture displacement and stress. Tensile break strength is defined as the maximum stress that the material can withstand before failure.

### Melting Point (ISO 11357-1)

The melting point was determined using a differential scanning calorimeter (DSC). A small quantity of the sample was sealed in a sample pan and placed in the DSC. The sample was then heated at a constant rate of 10 °C/min. The DSC recorded the heat flow, and an endothermic peak was observed near the melting point. The temperature corresponding to the maximum of this peak was defined as the sample's melting point.

### Hardness (ASTM D2240)

Hardness measurements were conducted using a Shore D durometer. A specimen with a thickness of 6 mm was prepared, and the durometer was applied vertically to the sample surface under a load of 50 N. After maintaining the pressure for 1 second, the hardness value was recorded. Multiple readings were taken at different locations on the specimen and averaged to obtain the final hardness value.

### Moisture Permeability (JIS L1099B-1)

Moisture permeability was determined using a water vapor permeability tester. In this procedure, a cup containing potassium acetate as a desiccant is sealed with an expanded polytetrafluoroethylene (ePTFE) film. The test sample is positioned with its active side facing the cup, which is then inverted and immersed in water. After a predetermined period, the change in the cup's weight is measured to calculate the amount of water vapor that has permeated through the sample. The moisture permeability is subsequently expressed in grams per square meter per 24 hours (g/m²·24 h).

### Example 1: Preparation of the Present TPEEs

In order to evaluate whether the TPEE prepared according to the disclosed method exhibits desirable physical properties and moisture permeability, three TPEE samples (Examples 1.1 to 1.3) were synthesized with varying material compositions following the procedures outlined in the “Materials and Methods” section and Section 2.1 as set forth above. Additionally, TPEE control samples (Comparative Examples 1.1 to 1.3) were prepared using a similar procedure, except without the incorporation of the ionic comonomer (e.g., DMSIP). The detailed experimental protocol is provided as follows:

### Example 1.1

Recycled PET (25 kg), 1,4-butanediol (25 kg), PEG (13.5 kg), and titanium butoxide (45 g) were added to the transesterification/ester exchange reaction vessel. The reaction was carried out at 220 °C for 6 hours under atmospheric pressure. After the ester exchange was completed, the product was transferred to the polymerization reaction vessel, where DMSIP (2 kg), sodium acetate (45 g), Irganox® 1010 (90 g), and titanium butoxide (34 g) were added. The temperature was raised to 245 °C while the pressure was reduced to below 1 torr, and the reaction was maintained for 3 to 4 hours. Upon reaching the specified mechanical torque value, the polymerization reaction vessel was depressurized to atmospheric pressure. The ester strands were then cooled in a water bath and subsequently cut into pellets using a pelletizer, thereby completing the production of the TPEE (Example 1.1) as disclosed.

### Example 1.2

Recycled PET (20 kg), 1,4-butanediol (21 kg), PEG (18 kg), and titanium butoxide (45 g) were added to the transesterification/ester exchange reaction vessel. The reaction was carried out at 220 °C for 6 hours under atmospheric pressure. After the ester exchange was completed, the product was transferred to the polymerization reaction vessel, where DMSIP (3.5 kg), sodium acetate (45 g), Irganox® 1010 (90 g), and titanium butoxide (34 g) were added. The temperature was raised to 245 °C while the pressure was reduced to below 1 torr, and the reaction was maintained for 3 to 4 hours. Upon reaching the specified mechanical torque value, the polymerization reaction vessel was depressurized to atmospheric pressure. The ester strands were then cooled in a water bath and subsequently cut into pellets using a pelletizer, thereby completing the production of the TPEE (Example 1.2) as disclosed.

### Example 1.3

Recycled PET (15 kg), 1,4-butanediol (17 kg), PEG (22.5 kg), and titanium butoxide (45 g) were added to the transesterification/ester exchange reaction vessel. The reaction was carried out at 220 °C for 6 hours under atmospheric pressure. After the ester exchange was completed, the product was transferred to the polymerization reaction vessel, where DMSIP (4.25 kg), sodium acetate (45 g), Irganox® 1010 (90 g), and titanium butoxide (34 g) were added. The temperature was raised to 245 °C while the pressure was reduced to below 1 torr, and the reaction was maintained for 3 to 4 hours. Upon reaching the specified mechanical torque value, the polymerization reaction vessel was depressurized to atmospheric pressure. The ester strands were then cooled in a water bath and subsequently cut into pellets using a pelletizer, thereby completing the production of the TPEE (Example 1.3) as disclosed.

### Comparative Example 1.1

Recycled PET (19.5 kg), 1,4-butanediol (18 kg), PEG (18 kg), and titanium butoxide (45 g) were added to the transesterification/ester exchange reaction vessel. The reaction was carried out at 220 °C for 6 hours under atmospheric pressure. After the ester exchange was completed, the product was transferred to the polymerization reaction vessel, where Irganox® 1010 (90 g), and titanium butoxide (34 g) were added. The temperature was raised to 245 °C while the pressure was reduced to below 1 torr, and the reaction was maintained for 3 to 4 hours. Upon reaching the specified mechanical torque value, the polymerization reaction vessel was depressurized to atmospheric pressure. The ester strands were then cooled in a water bath and subsequently cut into pellets using a pelletizer, thereby completing the production of the TPEE (Comparative Example 1.1).

### Comparative Example 1.2

Recycled PET (16 kg), 1,4-butanediol (15 kg), PEG (22.5 kg), and titanium butoxide (45 g) were added to the transesterification/ester exchange reaction vessel. The reaction was carried out at 220 °C for 6 hours under atmospheric pressure. After the ester exchange was completed, the product was transferred to the polymerization reaction vessel, where Irganox® 1010 (90 g), and titanium butoxide (34 g) were added. The temperature was raised to 245 °C while the pressure was reduced to below 1 torr, and the reaction was maintained for 3 to 4 hours. Upon reaching the specified mechanical torque value, the polymerization reaction vessel was depressurized to atmospheric pressure. The ester strands were then cooled in a water bath and subsequently cut into pellets using a pelletizer, thereby completing the production of the TPEE (Comparative Example 1.2).

### Comparative Example 1.3

Recycled PET (13 kg), 1,4-butanediol (12 kg), PEG (27 kg), and titanium butoxide (45 g) were added to the transesterification/ester exchange reaction vessel. The reaction was carried out at 220 °C for 6 hours under atmospheric pressure. After the ester exchange was completed, the product was transferred to the polymerization reaction vessel, where Irganox® 1010 (90 g), and titanium butoxide (34 g) were added. The temperature was raised to 245 °C while the pressure was reduced to below 1 torr, and the reaction was maintained for 3 to 4 hours. Upon reaching the specified mechanical torque value, the polymerization reaction vessel was depressurized to atmospheric pressure. The ester strands were then cooled in a water bath and subsequently cut into pellets using a pelletizer, thereby completing the production of the TPEE (Comparative Example 1.3).

### Example 2: Characterization of the Present TPEEs

The purpose of this experiment is to compare the physical properties and moisture permeability of the disclosed embodiments and the control group. To achieve this, TPEE samples produced in Examples 1.1 to 1.3 and Comparative Examples 1.1 to 1.3 were subjected to melting point and hardness testing using the procedures described in the “Materials and Methods” section. Additionally, a portion of the TPEE was reheated, melted, and injection-molded into dumbbell-shaped test specimens with dimensions of 25 mm in length, 6 mm in width, and 3 mm in thickness, followed by tensile strength testing according to the same procedures. Furthermore, the TPEE was heated, melted, and extruded through a T-DIE to form a thin film, which was then cooled and wound onto a reel to produce a non-porous waterproof breathable membrane with a thickness of 20±10 μm. The moisture permeability of the resulting membrane was evaluated according to the procedures described in the “Materials and Methods” section.

The results for the physical properties of the TPEE and the moisture permeability of the resulting film are presented in Table 2.

TABLE 2
Comparative results

| | | Amount | | | | |
|---|---|---|---|---|---|---|
| | Amount | of ionic | Tensile | | | Melt- |
| | of PEG | comonomer | strength | MVTR | Hard- | ing |
| | added | added | (kgf/ | (g/m² · | ness | point |
| | (wt %) | (mol %) | cm²) | day) | (D) | (°C) |
| Example 1.1 | 30 | 5 | 451 | 35,442 | 55 | 203 |
| Example 1.2 | 40 | 10 | 346 | 55,131 | 43 | 189 |
| Example 1.3 | 50 | 15 | 104 | 100,120 | 28 | 167 |
| Comparative | 40 | 0 | 391 | 30,227 | 53 | 202 |
| Example 1.1 | | | | | | |
| Comparative | 50 | 0 | 289 | 53,134 | 40 | 190 |
| Example 1.2 | | | | | | |
| Comparative | 60 | 0 | 82 | 97,984 | 30 | 169 |
| Example 1.3 | | | | | | |

It was found that, as depicted in Table 2, the addition of an ionic comonomer to TPEE resulted in a material that exhibited both excellent tensile strength and high moisture vapor transmission rate (MVTR), compared to TPEE without the ionic comonomer. Specifically, Example 1.1, which contained 5 mol % of the ionic comonomer, demonstrated a tensile strength of 451 kgf/cm² and an MVTR of 35,442 g/m²·day, whereas Comparative Example 1.1, which lacked the ionic comonomer, exhibited a lower tensile strength of 391 kgf/cm² and a reduced MVTR of 30,227 g/m²·day.

Furthermore, a comparison between Example 1.2 and Comparative Example 1.1, both containing the same amount of PEG (40 wt %), revealed that their tensile strengths were comparable (346 kgf/cm² vs. 391 kgf/cm²). However, the MVTR of Example 1.2, which included the ionic comonomer, was 55,131 g/m²·day-1.8 times higher than that of Comparative Example 1.1 (30,227 g/m²·day). This indicates that the addition of the ionic comonomer significantly enhanced the moisture permeability of TPEE without compromising its mechanical strength.

On the other hand, the hardness values remained relatively consistent between the comparative and experimental groups. For instance, Example 1.1 and Comparative Example 1.1 exhibited similar hardness values of 55 D and 53 D, respectively, while Example 1.3 and Comparative Example 1.3 showed values of 28 D and 30 D, respectively. These results suggest that the addition of an ionic comonomer did not significantly affect the hardness of TPEE within the studied range.

Similarly, the melting point was not notably influenced by the presence of the ionic comonomer. The melting points of the experimental and comparative examples were comparable across all samples, indicating that the modification did not substantially alter the thermal stability of TPEE.

Overall, these results demonstrate that the incorporation of an appropriate amount of the ionic comonomer into TPEE can effectively balance tensile strength and moisture permeability while maintaining comparable hardness and thermal properties.

It will be understood that the above description of embodiments is given by way of example only and that various modifications may be made by those with ordinary skill in the art. The above specification, examples, and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention.

What is claimed is:

1. A thermoplastic polyester elastomer (TPEE) comprising a rigid segment and a flexible segment connected with each other through chemical bonds,
wherein,
the rigid segment comprises a polyester, a polyol, and an ionic comonomer, and the flexible segment comprises a polyether;
the rigid segment is present in about 15% to 75% by weight percentage (wt %) of the total weight of the TPEE, and the flexible segment is present in about 20% to 80% by weight percentage (wt %) of the total weight of the TPEE; and
in the rigid segment, the ionic comonomer is present in a molar percentage (mol %) of 0.1 to 20 relative to the total molar amounts of the polyester.

2. The TPEE of claim 1, wherein the polyester is a recycled polyester.

3. The TPEE of claim 1, wherein the polyester is selected from the group consisting of polyethylene terephthalate (PET), polybutylene terephthalate (PBT), polytrimethylene terephthalate (PTT), polylactic acid (PLA), polycyclohexylene dimethylene terephthalate (PCT), polyethylene naphthalate (PEN), liquid crystal polyester (LCP), and a combination thereof.

4. The TPEE of claim 1, wherein the polyol is selected from the group consisting of 1,4-butanediol (BDO), ethylene glycol (EG), 1,6-hexanediol (HDO), neopentyl glycol (NPG), and a combination thereof.

5. The TPEE of claim 1, wherein the ionic comonomer is selected from the group consisting of sodium dimethyl 5-sulphonatoisophthalate (DMSIP), sodium 4-vinylbenzenesulfonate (SSS), sodium methacrylate (SMA), potassium 3-sulfopropyl methacrylate (SPMA), poly(sodium styrene sulfonate) (PSS), and a combination thereof.

6. The TPEE of claim 1, wherein the polyether is selected from the group consisting of polyethylene glycol (PEG), polypropylene glycol (PPG), polytetramethylene ether glycol (PTMEG), polytetrahydrofuran (PTHF), poly(ethylene-co-propylene) glycol (PEPG), polyoxetane (POX), and a combination thereof.

7. The TPEE of claim 1, wherein the polyester is a recycled polyethylene terephthalate (rPET), the polyol is 1,4-butanediol (BDO), the ionic comonomer is sodium dimethyl 5-sulphonatoisophthalate (DMSIP), and the polyether is polyethylene glycol (PEG).

8. The TPEE of claim 1, wherein the chemical bonds are ester bonds.

9. The TPEE of claim 1, wherein the rigid segment is present in about 45% to 55% by weight (wt %) of the total weight of the TPEE, and the flexible segment is present in about 40% to 50% by weight (wt %) of the total weight of TPEE.

10. The TPEE of claim 1, wherein the ionic comonomer is present in a molar percentage (mol %) of 10 to 20 relatives to the total molar amounts of the polyester.

11. The TPEE of claim 1, wherein the TPEE is characterized by having a moisture vapor transmission rate (MVTR) greater than 30,000 g/m²·24 h.

12. A waterproof breathable film comprising the thermoplastic polyester elastomer (TPEE) of claim 1, wherein the waterproof breathable film has a thickness of 10 to 450 μm.

13. The waterproof breathable film of claim 12, wherein the waterproof breathable film is characterized by having a moisture vapor transmission rate (MVTR) greater than 30,000 g/m²·24 h.

14. A method for producing a thermoplastic polyester elastomer (TPEE) of claim 1, comprising:
(a) mixing a polyester, a polyol, a polyether, and a titanium catalyst at a first temperature ranging from 200 °C to 250 °C and under a first pressure for 2 to 8 hours, to produce an intermediate product; and
(b) adding and mixing an ionic comonomer and the titanium catalyst with the intermediate product obtained from step (a) at a second temperature ranging from 220 °C to 270 °C and under a second pressure for 2 to 8 hours, thereby producing the TPEE,
wherein the second temperature is greater than the first temperature,
wherein the ionic comonomer is added in step (b) with a molar percentage (mol %) of 0.1 to 20 relative to the total molar amounts of the polyester in step (a).

15. The method of claim 14, wherein in step (a), the titanium catalyst is selected from the group consisting of titanium butoxide (Ti(OBu)₄), titanium tetrachloride (TiCl₄), titanium isopropoxide (Ti[OCH(CH₃)₂]₄), titanium (IV) acetylacetonate (Ti(acac)₄), titanium dioxide (TiO₂), and a combination thereof.

16. The method of claim 15, wherein the titanium catalyst is titanium butoxide.

17. The method of claim 14, wherein in the step (a) or (b), the titanium catalyst is added at an amount of 0.01 to 1 mmol.

18. The method of claim 14, wherein in step (a), the polyol is added in an amount equal to or greater than the weight of the polyester.

19. The method of claim 14, wherein in step (a), the first pressure is about 1 atm to 2.5 atm, and in step (b), the second pressure is about less than 0.05 atm.

20. The method of claim 14, wherein the polyester is a recycled polyester selected from the group consisting of polyethylene terephthalate (PET), polybutylene terephthalate (PBT), polytrimethylene terephthalate (PTT), polylactic acid (PLA), polycyclohexylene dimethylene terephthalate (PCT), polyethylene naphthalate (PEN), liquid crystal polyester (LCP), and a combination thereof.

21. The method of claim 14, wherein the polyol is selected from the group consisting of 1,4-butanediol (BDO), ethylene glycol (EG), 1,6-hexanediol (HDO), neopentyl glycol (NPG), and a combination thereof.

22. The method of claim 14, wherein the polyether is selected from the group consisting of polyethylene glycol (PEG), polypropylene glycol (PPG), polytetramethylene ether glycol (PTMEG), polytetrahydrofuran (PTHF), poly(ethylene-co-propylene) glycol (PEPG), polyoxetane (POX), and a combination thereof.

23. The method of claim 14, wherein the ionic comonomer is selected from the group consisting of sodium dimethyl 5-sulphonatoisophthalate (DMSIP), sodium 4-vinylbenzenesulfonate (SSS), sodium methacrylate (SMA), potassium 3-sulfopropyl methacrylate (SPMA), poly(sodium styrene sulfonate) (PSS), and a combination thereof.

24. The method of claim 14, wherein the polyester is a recycled polyethylene terephthalate (rPET), the polyol is 1,4-butanediol (BDO), the polyether is polyethylene glycol (PEG), and the ionic comonomer is sodium dimethyl 5-sulphonatoisophthalate (DMSIP).

25. The method of claim 14, wherein in step (b), an antioxidant is mixed with the ionic comonomer, the titanium catalyst, and the intermediate product.
